(19) United States
(12) Patent Application Publication
(10) Pub. No.: US 2026/0276990 A1
(43) Pub. Date: Sep. 17, 2026

(54) OPTICAL MODULE AND HEAD-MOUNTED DISPLAY DEVICE

(71) Applicant: Goertek Optical Technology Co., Ltd., Shandong (CN)

(72) Inventor: YUDENG WU, Shandong (CN)

(73) Assignee: Goertek Optical Technology Co., Ltd., Shandong (CN)

(21) Appl. No.: 18/877,892

(22) PCT Filed: Jun. 20, 2022
(86) PCT No.: PCT/CN2022/099808

§ 371 Date: Dec. 20, 2024

(51) Int. Cl. G02B 27/01; G02B 5/30; G02B 27/10

(52) U.S. Cl. CPC G02B 27/0172; G02B 5/3025; G02B 5/3083; G02B 27/106; G02B 2027/0161

(57) ABSTRACT

Embodiments of the present disclosure provide an optical module and a head mounted display. The optical module includes: a display screen, a lens group in proximity to a light-emergent surface of the display screen and the lens group comprising a lens adjacent to the display screen; the lens comprises a surface facing towards the display screen, and a distance between the surface and the display screen is A4, a polarization element, a splitting element, and a first phase retarder, where the splitting element is positioned on one side of the surface of the lens, the polarization element is positioned on one side of the lens facing away from the display screen, and the first phase retarder is positioned between the polarization element and the splitting element; wherein the optical module satisfies: A4/F²>0.008, wherein F is a focal length of the optical module.

### CROSS-REFERENCE TO RELATED APPLICATIONS

The present disclosure is a National Stage of International Application No. PCT/CN2022/099808, filed on Jun. 20, 2022, which is hereby incorporated by reference in its entirety.

### TECHNICAL FIELD

Embodiments of the present disclosure relate to the technical field of near-eye display imaging, and particularly to an optical module and a head mounted display.

### BACKGROUND

In recent years, augmented reality (AR) and virtual reality (VR) technologies have found applications and experienced rapid development in smart wearable devices, for example. The core component of both AR and VR technologies is the optical module. The quality of images displayed by the optical module directly determines the quality of smart wearable devices.

Nowadays, many smart wearable devices, such as VR devices, employ an optical path folding scheme. This scheme can effectively reduce the total length of the optical system; however, within the entire optical structure, the optic (lens) close to the display screen is relatively close to the light emitting surface of the display screen, and this can cause the defects in the appearance of the optic (lens) to be magnified after passing through other optical elements on the side distal to the display screen, making the defects more noticeable to the human eye and potentially degrading the quality of the imaging picture.

### SUMMARY

An objective of the present disclosure is to provide new technical solutions for an optical module and a head mounted display.

In a first aspect, the present disclosure provides an optical module, which comprises:
a display screen;
a lens group in proximity to a light-emergent surface of the display screen and comprising a lens adjacent to the display screen; the lens comprises a surface facing towards the display screen, and a distance between the surface and the display screen is A4;
the optical module further comprises a polarization element, a splitting element and a first phase retarder, with the splitting element located on one side of the surface of the lens, the polarization element located on one side of the lens facing away from the display screen, and the first phase retarder located between the polarization element and the splitting element;
wherein the optical module satisfies: A4/F²>0.008, wherein F is a focal length of the optical module.

Optionally, the optical module has an effective focal length F of 15 mm to 36 mm.

Optionally, an incident angle of a marginal field of view of the optical module is: −41° to 5°.

Optionally, a distance A2 between the polarization element and the splitting element is 4 mm to 15 mm.

Optionally, a distance from a virtual image made by a defect on the surface to a human eye is less than 120 mm.

Optionally, the lens group comprises a first lens provided close to a human eye, and the first lens comprises a second surface facing towards the display screen and a first surface facing away from the display screen;

the polarization element is provided on one side of the first surface of the first lens, or on one side of the second surface of the first lens.

Optionally, the lens group comprises a first lens provided close to a human eye, and the first lens comprises a second surface facing towards the display screen and a first surface facing away from the display screen;
the first phase retarder is provided on one side of the first surface of the first lens, or on one side of the second surface of the first lens;
wherein the first phase retarder is provided closer to the display screen than the polarization element.

In a second aspect, ahead mounted display is provided, which comprises:
a housing; and
the optical module according to the first aspect.

According to the embodiment disclosed herein, the ratio between the distance from the display screen to the surface of the nearest lens facing it and the square of the focal length of the optical module is controlled. This control ensures that any defects on the surface of the nearest lens, which faces the display screen, are less likely to be observed by the human eye, thereby enhancing the user's visual experience.

Other features and advantages of the present description will become clear by the following detailed description of the exemplary embodiment of the present description with reference to the accompanying drawings.

### BRIEF DESCRIPTION OF THE DRAWINGS

The accompanying drawings, which are incorporated in the description and constitute a part of the description, illustrate embodiments of the present disclosure and, together with the description thereof, serve to explain the principles of the present disclosure.

FIG. 1 illustrates a first schematic structural diagram of the optical module provided by an embodiment of the present disclosure.

FIG. 2 illustrates a second schematic structural diagram of the optical module provided by an embodiment of the present disclosure.

FIG. 3 illustrates a third schematic structural diagram of the optical module provided by an embodiment of the present disclosure.

FIG. 4 illustrates a fourth schematic structural diagram of the optical module provided by an embodiment of the present disclosure.

FIG. 5 illustrates a fifth schematic structural diagram of the optical module provided by an embodiment of the present disclosure.

FIG. 6 illustrates a sixth schematic structural diagram of the optical module provided by an embodiment of the present disclosure.

### DESCRIPTION OF REFERENCE SIGNS

1, display screen; 2, lens group; 21, first lens; 22, second lens; 23, third lens; 3, polarization element; 4, stop; 5, splitting element; 6, first phase retarder.

### DETAILED DESCRIPTION

Various exemplary embodiments of the present disclosure will now be described in detail with reference to the accompanying drawings. It is to be noted that unless otherwise specified, the scope of present disclosure is not limited to relative arrangements, numerical expressions and values of components and steps as illustrated in the embodiments.

Description to at least one exemplary embodiment is for illustrative purpose only, and in no way implies any restriction on the present disclosure or application or use thereof.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Different values may be available for alternative examples of the exemplary embodiments.

It is to be noted that similar reference numbers and alphabetical letters represent similar items in the accompanying drawings. In the case that a certain item is identified in a drawing, further reference thereof may be omitted in the subsequent drawings.

Here, in the design scheme of a pancake optical system, the scheme leverages the modulation effect of the polarization element on polarized light to achieve selective transmission or reflection of light with specific polarization states, thus enabling the folding of the optical path. When using the pancake design scheme, by increasing the distance between the polarization element and the splitting element, it is possible to reduce the total system length. The reduction in system length further decreases the distance between the display screen and the lens surface, causing any defect on the surface of the nearest lens to be magnified by the system and become observable to the human eye, thereby degrading the user experience. At present, in order to solve this technical problem, solutions have focused solely on increasing the distance between the lens close to the display screen and the light-emitting surface of the display screen in the optical path structure. However, if this distance becomes too large, it adversely affects the total optical length of the optical module.

To address the above technical problem, the first aspect of the embodiments disclosed in the present disclosure provides an optical module. The optical module features an optical structure design that uses a folded optical path, which can include at least one optical lens and can be applied to a head-mounted display (HMD), such as virtual reality (VR) head-mounted devices, including but not limited to VR glasses or VR helmets, etc., which is not specifically limited in the embodiments of the present disclosure.

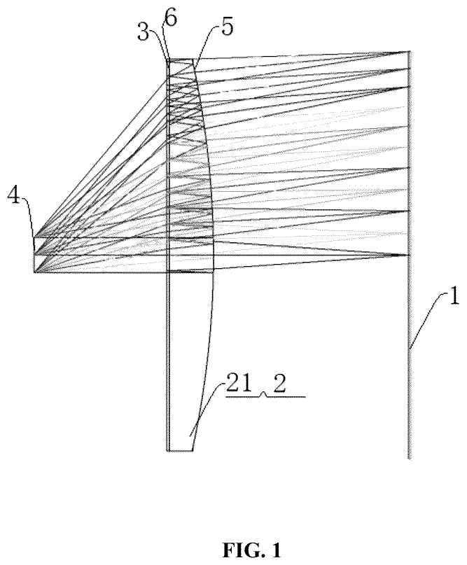

The following detailed description of the optical module and head mounted display provided by the embodiments of the present disclosure will be presented with reference to FIGS. 1 to 6.

Embodiments of the present disclosure provide an optical module. As shown in FIGS. 1 to 6, the optical module includes: a display screen 1; a lens group 2 in proximity to a light-emergent surface of the display screen 1 and including a lens adjacent to the display screen 1; the lens includes a surface facing towards the display screen 1, and a distance between the surface and the display screen 1 is A4.

The optical module further includes a polarization element 3, a splitting element 5 and a first phase retarder 6, the splitting element 5 is located on one side of the surface of the lens, the polarization element 3 is located on one side of the lens facing away from the display screen 1, and the first phase retarder 6 is located between the polarization element 3 and the splitting element 5; wherein the optical module satisfies: A4/F²>0.008, wherein F is a focal length of the optical module.

In other words, the optical module mainly includes the display screen 1, the lens group 2, the polarization element 3, the splitting element 5, and the first phase retarder 6.

Here, the display screen 1 may be an LCD (Liquid Crystal Display), LED (Light Emitting Diode), OLED (Organic Light-Emitting Diode), Micro-OLED (Micro-Organic Light-Emitting Diode), ULED (Ultra Light Emitting Diode), or DMD (Digital Micro mirror Device).

Here, the lens group 2 includes at least one lens, and functions to magnify and analyze light. For example, in a display device such as VR (Virtual Reality), to ensure that the user can obtain the magnified display picture, the light needs to be magnified, and the lens group 2 ensures that the user can obtain a recognizable, magnified picture. In folded optical paths, since light has already undergone folding processing, the number of lenses in an optical architecture employing the folded optical path can be at most three compared with a direct projection optical architecture.

To achieve the folded optical path, the optical module further includes a polarization element 3, a splitting element 5, and a first phase retarder 6.

Here, the splitting element 5 is located on the surface of the lens adjacent to the display screen 1 that faces towards it. Specifically, the lens group includes a lens adjacent to the display screen 1, which includes a surface facing towards the display screen. The splitting element 5 is provided on one side of the surface. Specifically, the splitting element 5 may be provided on the surface or between the lens and the display screen 1. For example, the splitting element 5 may be located between the lens and the display screen 1 via an optical component.

In the present embodiment, for example, when light passes through the splitting element 5, some of the light transmits while the rest is reflected, without accounting for any absorption of light. The splitting element 5 may be a transflective film or a polarizing film.

Here, the polarization element 3 is located on one side of the lens facing away from the display screen 1. Specifically, regardless of whether the lens group consists of one, two, or more lenses, the polarization element 3 should be provided on one side of the lens (a lens adjacent to the display screen 1) facing away from the display screen 1. For example, the polarization element 3 may be provided on the surface of the lens facing away from the display screen 1.

Here, the polarization element 3 may transmit P-polarized light and reflect S-polarized light; or, the polarization reflective element may transmit S-polarized light and reflect P-polarized light. Specifically, the polarization element 3 has a polarization-transmission direction, and only when the light vibrates along this polarization-transmission direction, it may pass through the polarization element 3 smoothly, while the light along the rest directions are reflected upon encountering the polarization element 3. For example, the polarization element 3 may be a structure such as a polarization reflection film or a reflective polarizer.

In the present embodiment, the first phase retarder 6 is located between the splitting element 5 and the polarization element 3. This positioning holds true whether or not lenses from the lens group are considered. Similar to the splitting element 5 and the polarization element 3, the first phase retarder 6 can also be provided on a lens from the lens group, meaning that both the lens and the first phase retarder 6 are located between the splitting element 5 and the polarization element 3.

In the present embodiment, the first phase retarder 6 may function to alter the polarization state of light in the folded optical path structure. For example, it can convert linearly polarized light into circularly polarized light or vice versa. For example, the first phase retarder 6 may be a quarter-wave plate.

Here, the lens group 2 is in proximity to the light-emergent surface of the display screen 1. Light emitted from the display screen 1 undergoes processing by the lens group, the splitting element 5, the first phase retarder 6, and the polarization element 3, before entering the human eye to form an image. The lens group 2 includes the lens nearest to the display screen 1, featuring a lens surface facing towards the display screen 1.

In the embodiments of the present disclosure, the distance A4 between said surface and the display screen 1, along with the focal length F of the optical module, is limited within this range to prevent the defects on the surface, which faces towards the display screen 1, of the lens nearest to the display screen 1 from being easily observed by the human eye.

Specifically, because the typical visual range of the normal human eye extends from 120 mm in front of the pupil to infinity (for example, it can be 700 m to 800 m), based on this, A4 may be optimized so that the virtual image formed by the defect on this surface is outside the visual range of the human eye. That is, the distance between the virtual image formed by the defect on this surface and the human eye is less than 120 mm.

To ensure that the distance between the virtual image formed by the defect on this surface and the human eye is less than 120 mm, we apply Newton's formula in geometric optics: X*X′=F*F (1). Here, X represents the distance from the surface (i.e., the surface with the defect), which faces towards the display screen 1, of the lens nearest to the display screen 1 to the focus of the optical module; X′ represents the distance from the virtual image formed by the defect on the surface, which faces towards the display screen 1, of the lens nearest to the display screen 1 to the human eye, and F is the focal length of the optical module.

When the distance X′ from the virtual image formed by the defect on the surface, which faces towards the display screen 1, of the lens nearest to the display screen 1 to the human eye is known (and in the present embodiment, X′ is required to be less than 120 mm), we can obtain X, the distance from the surface (i.e., the surface with the defect), which faces towards the display screen 1, of the lens nearest to the display screen 1 to the focus of the optical module may be obtained. That is, X=F*F/X′ (2).

In general, the distance VID from the virtual image designed by the optical module to the human eye is 1.5 m~3 m. Based on this, it can be obtained that the distance from the light-emitting surface of the display screen 1 to the focus of the optical module is X_{display}=F*F/VID (3).

When the distance A4 from the surface, which faces towards the display screen 1, of the lens nearest to the display screen 1 to the display screen 1 is greater than “X−X_{display}”, the defect on the surface, which faces towards the display screen 1, of the lens nearest to the display screen 1 is less recognizable by the human eye.

Since A4>“X−X_{display}”, i.e., A4>“F*F/X′−F*F/VID” so that A4>0.008*F*F. That is, this embodiments limits A4/F²>0.008, preventing the appearance defects on the lens (the lens nearest to the display screen 1) from being easily noticed by the human eye, thereby avoiding adverse effects on the imaging quality and ensuring a better user experience.

Here, the optical module satisfies Newton's formula in geometric optics X*X′=F*F (1). Specifically, for cases where the object-side focal length and the image-side focal length are unequal, the Newton's formula in geometric optics becomes X*X′=f*f′, wherein f is the object-side focal length, and f′ is the image-side focal length. Given f/n=−f′/n′, wherein f is the object-side focal length, f′ is the image-side focal length, n is the refractive index of the object-side space and n′ is the refractive index of the image-side space, when the refractive indices of the object-side space and the image-side space are the same, the object-side focal length and the image-side focal length are equal. In this optical module, both the object-side space and the image-side space are filled with air, and the refractive indices of the object-side space and the image-side space are the same. Thus, the object-side focal length and the image-side focal length are equal, and they can be uniformly defined as the focal length F of the optical module. Therefore, the Newton's formula in geometric optics applicable to the optical module in the present embodiment is X*X′=F*F (1).

In summary, this embodiment specifies the relationship between the distance A4 from the surface of the lens nearest to the display screen 1, which faces towards the display screen 1, to the display screen 1, and the focal length F of the optical module. That is, by ensuring that A4/F²>0.008, it is possible to make the defects on the surface of the lens nearest to the display screen 1 less recognizable by the human eye.

It should be noted that in the embodiments of the present disclosure, those skilled in the art can flexibly adjust the ratio relationship between the distance A4 (from the surface, which faces towards the display screen 1, of the lens nearest to the display screen 1 to the display screen 1), and the square of the focal length F of the optical module according to specific needs, as long as the ratio relationship remains within a preset range.

For example, the range of A4/F² may be greater than 0.01.

Alternatively, for example, the range of A4/F² may be greater than 0.015.

Of course, in the embodiments of the present disclosure, the ratio relationship between the distance A4 from the surface, which faces towards the display screen 1, of the lens nearest to the display screen 1 to the display screen 1, and the square of the focal length F of the optical module is not limited to the above examples; which may be flexibly adjusted by those skilled in the art according to the needs, and is not specifically limited in the embodiments of the present disclosure.

In one embodiment, the optical module has an effective focal length F of 15 mm to 36 mm.

In the present embodiment, the focal length F of the optical module is limited, wherein the focal length F of the optical module may refer to either the object-side focal length or the image-side focal length, and in the architecture of the optical module, the object-side focal length and the image-side focal length are equal.

Specifically, in the optical module, both the object-side space and the image-side space are filled with air, meaning that the refractive indices of the object-side space and the image-side space are the same. According to f/n=−f′/n′, wherein f is the object-side focal length, f′ is the image-side focal length, n is the refractive index of the object-side space, and n′ is the refractive index of the image-side space, when the refractive indices of the object-side space and the image-side space are the same, the object-side focal length and the image-side focal length are equal.

In the present embodiment, by limiting the focal length F of the optical module, on the one hand, to shorten the total optical length of the optical module and reduce the volume of the optical module; on the other hand, by limiting the focal length F of the optical module within this range, it is possible to ensure that the ratio of A4 to the square of the focal length F of the optical module satisfy the aforementioned ratio relationship, preventing the appearance defects on the lens (the lens nearest to the display screen 1) from being easily noticed by the human eye, thereby avoiding adverse effects on the imaging quality and ensuring a better user experience.

In an optional embodiment, the distance A4 between said surface and the display screen 1 is 2 mm-23 mm.

In an optional embodiment, the distance A4 from the surface, which faces towards the display screen 1, of the lens nearest to the display screen 1 (that is, the lens surface nearest to the display screen 1) to the display screen 1 is limited, wherein A4 may be 2 mm-8 mm, 8 mm-15 mm, 15 mm-20 mm, 20 mm-23 mm. The present embodiment limits the distance A4 from the surface, which faces towards the display screen 1, of the lens nearest to the display screen 1 (that is, the lens surface nearest to the display screen 1), to the display screen 1, which on the one hand controls the distance from the surface, which faces towards the display screen 1, of the lens nearest to the display screen 1, to the display screen 1 within a suitable range so as to meet the purpose of reducing the total optical length of the optical module, and on the other hand controls the distance from the surface, which faces towards the display screen 1, of the lens nearest to the display screen 1, to the display screen 1 within a suitable range such that the ratio of A4 to the square of the focal length F of the optical module satisfies the above ratio relationship, preventing the appearance defects on the lens (the lens nearest to the display screen 1) from being easily noticed by the human eye, thereby avoiding adverse effects on the imaging quality and ensuring a better user experience.

In one embodiment, an incident angle of a marginal field of view of the optical module is: −41° to 5°.

In the present embodiment, the incident angle of the marginal field of view (since light is reversible, the optical module architecture is designed in the opposite direction of the light transmission direction from the display screen, i.e., it may be understood as the emergent angle of the light from the display screen) is limited, for example, the incident angle of the marginal field of view may be −1°~5°, −10°~−1°, −20°~−10°, −35°~−20°. The present embodiment limits the incident angle of the marginal field of view, i.e., limits the angle of the light emergent from the display screen 1 within a suitable range, enhancing the brightness uniformity of the overall picture.

In one embodiment, the distance A2 between the polarization element 3 and the splitting element 5 is 4 mm to 15 mm.

In the present embodiment, the distance between the polarization element 3 and the splitting element 5 is limited, i.e., the length of the folded optical path in the optical module is limited. Here, the longer the folded optical path between the polarization element 3 and the splitting element 5, the longer the distance between the polarization element 3 and the splitting element 5, and the shorter the total optical length of the optical module. Specifically, due to the existence of the folded optical path, the folded optical path equivalently increases the doubled optical focal characteristics which are provided by the number of lenses and the reflection surface (the reflection of splitting element 5, or the reflection of polarization element 3), makes the total optical length of the optical module shorter.

Therefore, by increasing the distance between the polarization element 3 and the splitting element 5, it is possible to reduce the total optical length of the optical module. However, the reduction in the total optical length of the optical module further reduces the distance A4 between the display screen 1 and the surface facing towards the display screen 1 of the lens nearest to the display screen 1, and any defect on the surface of the lens nearest to the display screen will be magnified by the optical elements in the optical module away from the display screen, making them easily recognizable by the human eye and impacting the visual experience of the user.

In the present embodiment, by limiting the distance between the polarization element 3 and the splitting element 5 within this range, the total optical length of the optical module and the distance A4 of the surface facing towards the display screen 1 of the lens nearest to the display screen 1 are reasonably matched. Under the premise of not significantly affecting the total optical length of the optical module, the ratio of A4 to the square of the focal length F of the optical module satisfies the aforementioned ratio relationship, such that the defect on the lens surface is less recognizable by the human eye, preventing the appearance defects on the lens (the lens nearest to the display screen 1) from being easily noticed by the human eye, thereby avoiding adverse effects on the imaging quality and ensuring a better user experience.

In one embodiment, the distance from a virtual image made by a defect on the surface to a human eye is less than 120 mm.

In the present embodiment, it is specified that the distance between the virtual image formed by the defect on the surface of the lens nearest to the display screen 1 and the human eye is less than 120 mm, making the defect on the lens surface less recognizable by the human eye.

Specifically, the visual range of a normal human eye generally ranges from 120 mm in front of the pupil to infinity (for example, it may be 700 m~800 m). When a virtual image of an object is formed outside the visual range of the human eye, that is, when the distance between the virtual image of the object and the human eye is less than 120 mm, the human eye cannot recognize the virtual image formed by this object.

Therefore, the ratio of the distance A4 between the surface facing towards the display screen 1 of the lens nearest to the display screen 1 and the display screen 1 to the square of the focal length F of the optical module is defined according to the above discussion. When the ratio relationship of the distance A4 between the surface facing towards the display screen 1 of the lens nearest to the display screen 1 and the display screen 1 to the square of the focal length F of the optical module satisfies the aforementioned range, a distance between the virtual image formed by the defect on the surface of the lens nearest to the display screen 1 and the human eye is less than 120 mm.

Here, when the ratio relationship of the distance A4 between the surface facing towards the display screen 1 of the lens nearest to the display screen 1 and the display screen 1 to the square of the focal length F of the optical module satisfies the aforementioned range, a distance between the virtual image formed by the defect on the surface of the lens nearest to the display screen 1 and the human eye is less than 120 mm. Specifically, according to X=F²/X′, X_{display}=F²/VID, A4>X-X_{display}, the shorter the X′ distance, the larger the A4 distance. (The above has been explained previously and is not repeated here).

Here, X is the distance between the surface facing towards the optical module of the lens nearest to the display screen 1 and focus of the optical module, F is the focal length of the optical module, X′ is the distance between the virtual image and the human eye, X_{display} is the distance between the screen and the focus of the optical module, and VID is the distance between the virtual image designed in the optical module and the human eye, and generally ranges from 1.5 m to 3 m.

Therefore, when it is specified that the distance between the virtual image formed by the defect on the surface of the lens nearest to the display screen 1 and the human eye is less than 120 mm, the defect on the surface of the lens is less recognizable by the human eye.

In one embodiment, the lens group 2 includes a first lens 21 provided close to a human eye, and the first lens includes a second surface facing towards the display screen 1 and a first surface facing away from the display screen 1; the polarization element 3 is provided on one side of the first surface of the first lens, or on one side of the second surface of the first lens.

In the present embodiment, regardless of whether the lens group 2 consists of one lens, two lenses, three lenses, or any other number, the lens group 2 always has a near-human eye side, and comprise a first lens arranged close to the human eye. The polarization element 3 is provided on one side of the first surface of the first lens, or on one side of the second surface of the first lens.

In the present embodiment, as shown in FIG. 1, the lens group 2 only includes one lens, wherein the polarization element 3 is provided on the near-human eye side. For example, the polarization element 3 is attached to the surface of the lens facing towards the human eye (the first surface). Alternatively, an optical component is provided between the lens and the human eye, and the polarization element 3 is attached to the optical component.

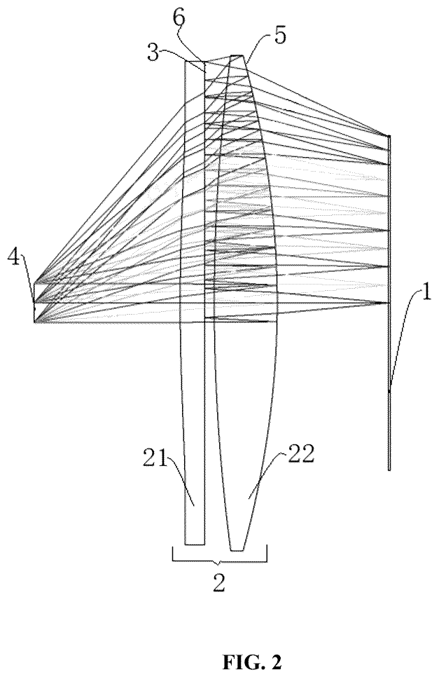

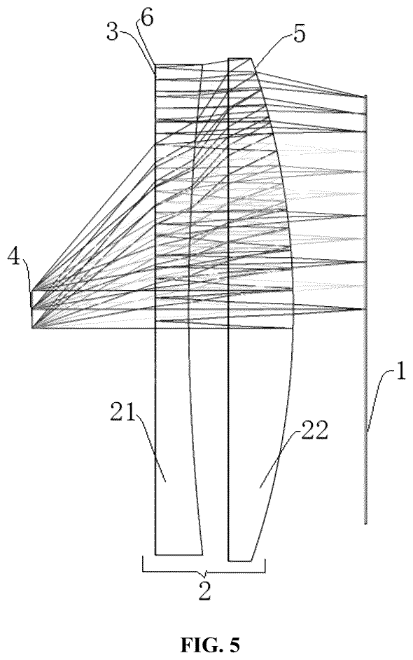

As shown in FIGS. 2 and 5, for example, the lens group 2 includes at least two lenses. The at least two lenses include the first lens 21 and the second lens 22, wherein the first lens 21 is provided close to the human eye, and the second lens 22 is provided close to the display screen 1. The polarization element 3 is provided between the first lens 21 and the second lens 22, for example, the polarization element 3 is provided on the surface of the first lens 21 away from the human eye (the second surface); or for example, an additional optical component is provided between the first lens 21 and the second lens 22, and the polarization element 3 is provided on the optical component.

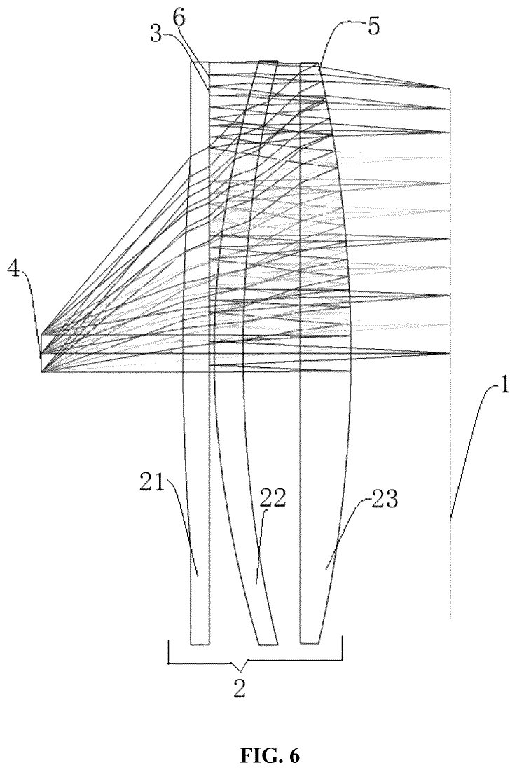

As shown in FIG. 6, for example, the lens group 2 includes at least two lenses. At least two lenses include the first lens 21, the second lens 22, and the third lens 23, wherein the first lens 21 is provided close to the human eye, the second lens 22 is located between the first lens 21 and the third lens 23, and the third lens 23 is provided nearest to the display screen 1. Here, the polarization element 3 is provided between the second lens 22 and the first lens 21, for example, on the second surface of the first lens 21 away from the human eye.

The present disclosure does not specifically limit the specific setting position of the polarization element 3, as long as it can make the distance between the polarization element 3 and the splitting element 5 satisfy the aforementioned limitation range.

In one embodiment, the lens group 2 includes the first lens 21 provided close to the human eye, and the first lens comprises a second surface facing towards the display screen 1 and a first surface facing away from the display screen 1;

the first phase retarder 6 is provided on one side of the first surface of the first lens, or on one side of the second surface of the first lens;

wherein the first phase retarder 6 is provided closer to the display screen 1 than the polarization element 3.

In the present embodiment, regardless of whether the lens group 2 consists of one lens, two lenses, three lenses, or any other number, the lens group 2 always has a near-human eye side, and comprises a first lens provided close to the human eye. The first phase retarder 6 is provided on one side of the first surface of the first lens, or on one side of the second surface of the first lens.

In the present embodiment, as shown in FIG. 1, the lens group 2 only includes one lens, wherein the first phase retarder 6 is provided on the near-human eye side of the lens. For example, the first phase retarder 6 is provided on the surface of the lens facing towards the human eye (the first surface). Alternatively, an optical component is provided between the lens and the human eye, and the first phase retarder 6 is attached to this optical component.

As shown in FIGS. 2 and 5, for example, the lens group 2 includes at least two lenses. At least two lenses include the first lens 21 and the second lens 22, wherein the first lens 21 is provided close to the human eye, and the second lens 22 is provided close to the display screen 1. The first phase retarder 6 is provided between the first lens 21 and the second lens 22, for example, on the surface of the first lens 21 away from the human eye (the second surface); or for example, an additional optical component is provided between the first lens 21 and the second lens 22, and the first phase retarder 6 is provided on the optical component.

As shown in FIG. 6, for example, the lens group 2 includes at least two lenses. At least two lenses include the first lens 21, the second lens 22, and the third lens 23, wherein the first lens 21 is provided close to the human eye, the second lens 22 is located between the first lens 21 and the third lens 23, and the third lens 23 is provided nearest to the display screen 1. The first phase retarder 6 is provided between the second lens 22 and the first lens 21, for example, on the second surface of the first lens 21 away from the human eye.

The present embodiments do not specifically limit the specific setting position of the polarization element 3, as long as it can make the first phase retarder 6 be provided closer to the display screen than the polarization element 3.

Specifically, the first phase retarder 6 is provided closer to the display screen than the polarization element 3. For example, both the first phase retarder 6 and the polarization element 3 are provided on the first surface (facing towards the human eye) of the first lens 21, with the first phase retarder 6 provided closer to the first lens 21 than the polarization element 3. Alternatively, both the first phase retarder 6 and the polarization element 3 are provided on the second surface (facing towards the second lens 22) of the first lens 21, with the first phase retarder 6 provided farther away from the first lens 21 than the polarization element 3.

The polarization state of the light is changed after passing through the first phase retarder 6, wherein the light passes through the first phase retarder 6 for the first time and is reflected by the polarization element 3, and the reflected light is processed by the splitting element 5 and then passes through the first phase retarder 6 again, wherein the light passing through the first phase retarder 6 for the second time is transmitted through the polarization element 3 and conveyed to the human eye.

According to the second aspect of the present disclosure, a head mounted display is provided. The head mounted display includes: a housing; and the optical module as described above. For example, the head mounted display includes the housing and the optical module according to the first aspect; or the head mounted display includes the housing and the optical module according to the second aspect.

The head mounted display is a VR head mounted device for example, including VR glasses or VR helmets, etc., which is not specifically limited by embodiments of the present disclosure.

The specific implementation of the head mounted display of the embodiments of the present disclosure may refer to each embodiment of the above display module, which will not be repeated herein.

The following six embodiments provide a detailed explanation of the optical module provided by the embodiments of the present disclosure.

### First Embodiment

As shown in FIG. 1, the optical module provided by the embodiments of the present disclosure includes a display screen 1, a first lens 21, a polarization element 3, a splitting element 5, and a stop 4, wherein the first lens 21 comprise a first surface facing towards the human eye and a second surface facing towards the display screen 1.

The splitting element 5 is provided on the second surface of the first lens 21, and the polarization element 3 and the first phase retarder 6 are provided on the first surface of the first lens 21. Here, the position of the stop 4 is at the location of the human eye.

Here, the distance A4 between the second surface of the first lens 21 and the display screen 1 is 22.0973 mm, the effective focal length F of the optical module is 28.79 mm; the distance A2 between the polarization element 3 and the splitting element 5 is 4.9943 mm.

Here, the optical parameters of the display screen 1, the first lens 21, and the stop 4 may refer to Table 1:

| | | Curvature | | Refractive | |
|---|---|---|---|---|---|
| | | Radius | Thickness | Index | Diameter |
| Type | Part | (mm) | (mm) | (Nd) | (mm) |
| Stop | Stop | Infinity | 15 | | 4 |
| First | P1S1 | Infinity | 4.9943 | 1.5447 | 44.34 |
| Lens | P1S2 | −101.582 | 22.0973 | 1.5447 | 44.34 |
| Display | Display | Infinity | | | 46 |
| Screen | | | | | |

The present embodiment is suitable for a 100° FOV and a 46 mm (medium-sized screen) image plane size, and in the present embodiment, A4/F*F=0.027>0.008. The appearance defect on the second surface of the first lens 21 in the optical module of the present embodiment is less recognizable by the human eye.

The present case is suitable for a 100° FOV and a 46 mm image plane size, and the light incidence angle of the marginal field of view is 5°. The display brightness of display screen 1 at this angle will decrease by no more than 10% compared to the display brightness at 0°, reducing the light intensity of the marginal field of view and enhancing the uniformity of the brightness of the display screen 1.

### Second Embodiment

As shown in FIG. 2, the optical module provided by the embodiments of the present disclosure includes a display screen 1, a first lens 21, a second lens 22, a polarization element 3, a splitting element 5, and a stop 4, wherein the first lens 21 comprises a second surface adjacent to the second lens 22, and a first surface facing towards the eye; the second lens 22 comprises a first surface adjacent to the first lens 21 and a second surface facing towards the display screen 1;

the splitting element 5 is provided on the second surface of the second lens 22, and the polarization element 3 and the first phase retarder 6 are provided on the second surface of the first lens 21. Here, the position of the stop 4 is at the location of the human eye.

Here, the distance A4 between the second surface of the second lens 22 and the display screen 1 is 11.4 mm, and the effective focal length F of the optical module is 21.47 mm; the distance A2 between the polarization element 3 and the splitting element 5 is 7.5 mm.

Here, the optical parameters of the display screen 1, the first lens 21, the second lens 22, and the stop 4 may refer to Table 2:

| | | Curvature | | Refractive | |
|---|---|---|---|---|---|
| | | Radius | Thickness | Index | Diameter |
| Type | Part | (mm) | (mm) | (Nd) | (mm) |
| Stop | Stop | Infinity | 15 | | 4 |
| First | P1S1 | 217.6 | 2.5 | 1.534 | 49.6 |
| Lens | P1S2 | Infinity | 1 | 1.534 | 49.6 |
| Second | P2S1 | 189 | 6.5 | 1.5447 | 50.8 |
| Lens | P2S2 | −89.9 | 11.4 | 1.5447 | 50.8 |
| Display | Display | Infinity | | | 34 |
| Screen | | | | | |

The present embodiment is suitable for a 100° FOV and a 34 mm (small-sized screen) image plane size, and in the present embodiment, A4/F*F=0.025>0.008. The appearance defect on the second surface of the second lens 22 in the optical module of the present embodiment is less recognizable by the human eye.

The present case is suitable for a 100° FOV and a 34 mm image plane size, and the light incidence angle of the marginal field of view is −20.1°. The display brightness of display screen 1 at this angle will decrease by no more than 25%-30% compared to the display brightness at 0°, reducing the light intensity of the marginal field of view and enhancing the uniformity of the brightness of the display screen 1.

### Third Embodiment

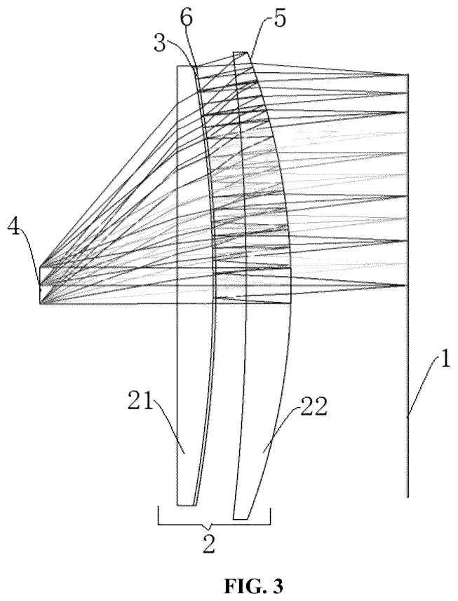

As shown in FIG. 3, the optical module provided by the embodiments of the present disclosure includes a display screen 1, a first lens 21, a second lens 22, a polarization element 3, a splitting element 5, and a stop 4, wherein the first lens 21 comprises a second surface adjacent to the second lens 22, and a first surface facing towards the eye; the second lens 22 comprises a first surface adjacent to the first lens 21 and a second surface facing towards the display screen 1;

the splitting element 5 is provided on the second surface of the second lens 22, and the polarization element 3 and the first phase retarder 6 are provided on the second surface of the first lens 21. Here, the position of the stop 4 is at the location of the human eye.

Here, the distance A4 between the second surface of the second lens 22 and the display screen 1 is 12.61 mm, and the effective focal length F of the optical module is 28.16 mm; the distance A2 between the polarization element 3 and the splitting element 5 is 8.49 mm.

Here, the optical parameters of the display screen 1, the first lens 21, the second lens 22, and the stop 4 may refer to Table 3:

| | | Curvature | | Refractive | |
|---|---|---|---|---|---|
| | | Radius | Thickness | Index | Diameter |
| Type | Part | (mm) | (mm) | (Nd) | (mm) |
| Stop | Stop | Infinity | 15 | | 4 |
| First | P1S1 | Infinity | 3.9 | 1.534 | 48 |
| Lens | P1S2 | −131.64 | 3.62 | 1.534 | 48 |
| Second | P2S1 | −228.64 | 4.87 | 1.5447 | 51 |
| Lens | P2S2 | −69.26 | 12.61 | 1.5447 | 51 |
| Display | Display | Infinity | | | 46 |
| Screen | | | | | |

The present embodiment is suitable for a 100° FOV and a 46 mm (medium-sized screen) image plane size, and in the present embodiment, A4/F*F=0.016>0.008. The appearance defect on the second surface of the second lens 22 in the optical module of the present embodiment is less recognizable by the human eye.

The present case is suitable for a 100° FOV and a 46 mm image plane size, and the light incidence angle of the marginal field of view is −0.9°. The display brightness of display screen 1 at this angle will decrease by no more than 10% compared to the display brightness at 0°, reducing the light intensity of the marginal field of view and enhancing the uniformity of the brightness of the display screen 1.

### Fourth Embodiment

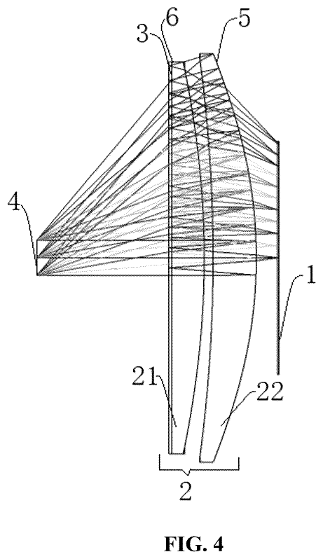

As shown in FIG. 4, the optical module provided by the embodiments of the present disclosure includes a display screen 1, a first lens 21, a second lens 22, a polarization element 3, a splitting element 5, and a stop 4, wherein the first lens 21 comprises a second surface adjacent to the second lens 22, and a first surface facing towards the eye; the second lens 22 comprises a first surface adjacent to the first lens 21 and a second surface facing towards the display screen 1;

the splitting element 5 is provided on the second surface of the second lens 22, and the polarization element 3 and the first phase retarder 6 are provided on the first surface of the first lens 21. Here, the position of the stop 4 is at the location of the human eye.

Here, the distance A4 between the second surface of the second lens 22 and the display screen 1 is 2.3821 mm, and the effective focal length F of the optical module is 15.73 mm; the distance A2 between the polarization element 3 and the splitting element 5 is 9.6088 mm.

Here, the optical parameters of the display screen 1, the first lens 21, the second lens 22, and the stop 4 may refer to Table 4:

| | | Curvature | | Refractive | |
|---|---|---|---|---|---|
| | | Radius | Thickness | Index | Diameter |
| Type | Part | (mm) | (mm) | (Nd) | (mm) |
| Stop | Stop | Infinity | 15 | | 4 |
| First | P1S1 | Infinity | 3.704 | 1.5447 | 44.5 |
| Lens | P1S2 | −100.191 | 0.9944 | 1.5447 | 44.5 |
| Second | P2S1 | −175.123 | 4.9104 | 1.5447 | 46.34 |
| Lens | P2S2 | −53.86 | 2.3821 | 1.5447 | 46.34 |
| Display | Display | Infinity | | | 26 |
| Screen | | | | | |

The present embodiment is suitable for a 100° FOV and a 26 mm (small-sized screen) image plane size, and in the present embodiment, A4/F*F=0.010>0.008. The appearance defect on the second surface of the second lens 22 in the optical module of the present embodiment is less recognizable by the human eye.

The present case is suitable for a 100° FOV and a 26 mm image plane size, and the light incidence angle of the marginal field of view is-41°. The display brightness of display screen 1 at this angle will decrease by no more than 30% compared to the display brightness at 0°, reducing the light intensity of the marginal field of view and enhancing the uniformity of the brightness of the display screen 1.

### Fifth Embodiment

As shown in FIG. 5, the optical module provided by the embodiments of the present disclosure includes a display screen 1, a first lens 21, a second lens 22, a polarization element 3, a splitting element 5, and a stop 4, wherein the first lens 21 comprises a second surface adjacent to the second lens 22, and a first surface facing towards the eye; the second lens 22 comprises a first surface adjacent to the first lens 21 and a second surface facing towards the display screen 1;

the splitting element 5 is provided on the second surface of the second lens 22, and the polarization element 3 and the first phase retarder 6 are provided on the first surface of the first lens 21. Here, the position of the stop 4 is at the location of the human eye.

Here, the distance A4 between the second surface of the second lens 22 and the display screen 1 is 7.5 mm, and the effective focal length F of the optical module is 29.06 mm; the distance A2 between the polarization element 3 and the splitting element 5 is 14.51 mm.

Here, the optical parameters of the display screen 1, the first lens 21, the second lens 22, and the stop 4 may refer to Table 5:

| | | Curvature | | Refractive | |
|---|---|---|---|---|---|
| | | Radius | Thickness | Index | Diameter |
| Type | Part | (mm) | (mm) | (Nd) | (mm) |
| Stop | Stop | Infinity | 13 | | 4 |
| First | P1S1 | Infinity | 3.5 | 1.5447 | 51.8 |
| Lens | P1S2 | 220 | 4.16 | 1.5447 | 51.8 |
| Second | P2S1 | Infinity | 6.85 | 1.5447 | 53.1 |
| Lens | P2S2 | −82.68 | 7.5 | 1.5447 | 53.1 |
| Display | Display | Infinity | | | 44.9 |
| Screen | | | | | |

The present embodiment is suitable for a 100° FOV and a 44.9 mm (medium-sized screen) image plane size, and in the present embodiment, A4/F*F=0.009>0.008. The appearance defect on the second surface of the second lens 22 in the optical module of the present embodiment is less recognizable by the human eye.

The present case is suitable for a 100° FOV and a 44.9 mm image plane size, and the light incidence angle of the marginal field of view is −9.13°. The display brightness of display screen 1 at this angle will decrease by no more than 25% compared to the display brightness at 0°, reducing the light intensity of the marginal field of view and enhancing the uniformity of the brightness of the display screen 1.

### Sixth Embodiment

As shown in FIG. 6, the optical module provided by the embodiments of the present disclosure includes a display screen 1, a first lens 21, a second lens 22, a third lens 23, a polarization element 3, a splitting element 5, and a stop 4, wherein the first lens 21 is provided nearest to the human eye, the third lens 23 is provided nearest to the display screen 1, and the second lens 22 is located between the first lens 21 and the third lens 23.

Here, the first lens 21 comprises a second surface adjacent to the second lens 22, and a first surface facing towards the eye; and the third lens 23 comprises a first surface adjacent to the second lens 22 and a second surface facing towards the display screen 1;

the splitting element 5 is provided on the second surface of the third lens 23, and the polarization element 3 and the first phase retarder 6 are provided on the second surface of the first lens 21. Here, the position of the stop 4 is at the location of the human eye.

Here, the distance A4 between the second surface of the third lens 23 and the display screen 1 is 10.5 mm, and the effective focal length F of the optical module is 35.08 mm; the distance A2 between the polarization element 3 and the splitting element 5 is 10.5 mm.

Here, the optical parameters of the display screen 1, the first lens 21, the second lens 22, the third lens 23, and the stop 4 may refer to Table 6:

| | | Curvature | | Refractive | |
|---|---|---|---|---|---|
| | | Radius | Thickness | Index | Diameter |
| Type | Part | (mm) | (mm) | (Nd) | (mm) |
| Stop | Stop | Infinity | 15 | | 4 |
| First | P1S1 | 250 | 2.806 | 1.534 | 61.68 |
| Lens | P1S2 | Infinity | 0.5 | 1.534 | 61.68 |
| Second | P2S1 | 96.05 | 3.06 | 1.5447 | 61.84 |
| Lens | P2S2 | 136.73 | 6.06 | 1.5447 | 61.84 |
| Third | P3S1 | Infinity | 5.34 | 1.5447 | 61.44 |
| Lens | P3S2 | −138.27 | 10.5 | 1.5447 | 61.44 |
| Display | Display | Infinity | | | 56 |
| Screen | | | | | |

The present embodiment is suitable for a 100° FOV and a 56 mm (medium-sized screen) image plane size, and in the present embodiment, A4/F*F=0.009>0.008. The appearance defect on the second surface of the third lens 23 in the optical module of the present embodiment is less recognizable by the human eye.

The present case is suitable for a 100° FOV and a 56 mm image plane size, and the light incidence angle of the marginal field of view is −6.36°. The display brightness of display screen 1 at this angle will decrease by no more than 15% compared to the display brightness at 0°, reducing the light intensity of the marginal field of view and enhancing the uniformity of the brightness of the display screen 1.

According to another aspect of the embodiments of the present disclosure, a head mounted device is further provided, which comprises a housing and the optical module as described above.

The above embodiments focus on the differences between the various embodiments, and the different optimization features between the various embodiments, as long as they do not contradict each other, may be combined to form a better embodiment, which will not be repeated herein taking into account the brevity of the text.

Although some specific embodiments of the present disclosure have been described in detail through examples, those skilled in the art should understand that the above examples are for illustration only and are not intended to limit the scope of the present disclosure. Those skilled in the art should understand that the above embodiments can be modified without departing from the scope and spirit of the present disclosure. The scope of the present disclosure is defined by the accompanying claims.

1. An optical module, comprising:
a display screen having a light-emergent surface,
a lens group positioned in proximity to the light-emergent surface and comprising a lens having a first surface facing towards the display screen with a distance A4 between the first surface and the display screen,
a polarization element,
a splitting element, and
a first phase retarder,
wherein, the splitting element is positioned on proximate to the first surface of the lens, the polarization element is positioned proximate to a second surface of the lens facing away from the display screen, and the first phase retarder is positioned between the polarization element and the splitting element;
wherein the optical module satisfies: A4/F²>0.008, wherein F is a focal length of the optical module.

2. The optical module according to claim 1, wherein the optical module has an effective focal length from 15 mm to 36 mm.

3. The optical module according to claim 1, wherein an incident angle of a marginal field of view of the optical module is from: −41° to 5°.

4. The optical module according to claim 1, wherein a distance A2 between the polarization element and the splitting element is between 4 mm to 15 mm.

5. The optical module according to claim 1, wherein a distance from a virtual image made by a defect on the surface to a human eye is less than 120 mm.

6. The optical module according to claim 1, wherein the lens group comprises a first lens in proximity to a human eye, and the first lens comprises a first surface facing away from the display screen and a second surface facing towards the display screen;
the polarization element is provided on one side of the first surface of the first lens, or on one side of the second surface of the first lens.

7. The optical module according to claim 1, wherein the lens group comprises a first lens in proximity to a human eye, and the first lens comprises a first surface facing away from the display screen and a second surface facing towards the display screen;
the first phase retarder is provided on one side of the first surface of the first lens, or on one side of the second surface of the first lens;
wherein the first phase retarder is nearer to the display screen than the polarization element.

8. A head mounted display, comprising:
a housing; and
an optical module according to claim 1.
